(19) United States
(12) Patent Application Publication
(10) Pub. No.: US 2013/0255402 A1
(43) Pub. Date: Oct. 3, 2013

(54) EXTERNAL FORCE DETECTION SENSOR AND EXTERNAL FORCE DETECTION EQUIPMENT

(71) Applicant: NIHON DEMPA KOGYO CO., LTD., Tokyo (JP)

(72) Inventors: MITSUAKI KOYAMA, Saitama (JP); TAKERU MUTOH, Saitama (JP)

(73) Assignee: NIHON DEMPA KOGYO CO., LTD., Tokyo (JP)

(21) Appl. No.: 13/853,077

(22) Filed: Mar. 29, 2013

(30) Foreign Application Priority Data
Apr. 2, 2012 (JP) 2012-084071

(51) Int. Cl. G01L 1/16

(52) U.S. Cl. CPC G01L 1/162
USPC 73/862.625

(57) ABSTRACT

An external force detection sensor includes a piezoelectric piece, excitation electrodes, an oscillation circuit, a movable electrode, and a fixed electrode. The fixed electrode forms variable capacitance with variation in capacitance between the fixed electrode and the movable electrode that is caused by deflection of the piezoelectric piece. The piezoelectric piece, the excitation electrode, the movable electrode, and the fixed electrode constitute combinations of a first combination and a second combination. The first combination constitutes a first sensor unit by disposing a first piezoelectric piece on a first crystal plane of the crystalline body. The second combination constitutes a second sensor unit by disposing a second piezoelectric piece on a second crystal plane. The second crystal plane does not opposite to the first crystal plane of the crystalline body. A relative position of the second crystal plane with respect to the first crystal plane is obtained.

### CROSS REFERENCE TO RELATED APPLICATIONS

This application claims the priority benefit of Japan application serial no. 2012-084071, filed on Apr. 2, 2012. The entirety of the above-mentioned patent application is hereby incorporated by reference herein and made a part of this specification.

### TECHNICAL FIELD

This disclosure relates to an external force detection sensor and an external force detection equipment that use a piezoelectric piece such as a crystal blank to detect a magnitude of an external force acting on the piezoelectric piece based on an oscillation frequency. The external force includes an acceleration, a pressure, a flow speed of fluid, a magnetic force, an electrostatic force, or similar force.

### DESCRIPTION OF THE RELATED ART

An external force acting on a system includes a force acting on an object based on acceleration, a pressure, a flow speed, a magnetic force, an electrostatic force, and similar force. It is often necessary to measure these external forces accurately. For example, in a stage of developing an automobile, an impact force to a seat when the automobile collides with an object is measured. In order to investigate vibration energy and amplitude during an earthquake, it is required to check acceleration of vibrations and similar parameter as accurate as possible. Additionally, vibration of motion of a robot hand or a flow speed of liquid or gas is accurately checked to reflect a detected value to a control system. Alternatively, magnet performance is measured. These cases are also examples of measurement for the external force. When this measurement is performed, measuring a direction and a magnitude of the external force with high accuracy is required. At this time, a simple device configuration and facilitated fabrication are preferred.

In FIG. 2, paragraph 0010, and paragraph 0016 of Japanese Unexamined Patent Application Publication No. H09-318364 (hereinafter referred to as Patent Literature 1), a piezoelectric vibrating gyro is proposed. This piezoelectric vibrating gyro has an angle of from 30 degrees to 75 degrees between an axial direction of a piezoelectric resonator and a pedestal reference surface of the piezoelectric resonator. However, Patent Literature 1 discloses a configuration that ensures a downsized piezoelectric vibrating gyro. This configuration cannot solve the problem of this disclosure, either.

A need thus exists for an external force detection sensor and external force detection equipment which is not susceptible to the drawback mentioned above.

### SUMMARY

An external force detection sensor according to this disclosure is for detecting an external force that acts on a piezoelectric piece. The external force detection sensor includes a piezoelectric piece, one excitation electrode, another excitation electrode, an oscillation circuit, a movable electrode for forming variable capacitance, and a fixed electrode. The piezoelectric piece has one end side supported by a pedestal. The pedestal is formed in a crystal plane. The one excitation electrode is disposed at one surface side of the piezoelectric piece. The another excitation electrode is disposed at another surface side of the piezoelectric piece. The oscillation circuit electrically connects to the one excitation electrode. The movable electrode is disposed in a portion distant from the one end side of the piezoelectric piece and electrically connects to the another excitation electrode. The fixed electrode is separated from the piezoelectric piece and faces the movable electrode. The fixed electrode connects to the oscillation circuit and forms variable capacitance with variation in capacitance between the fixed electrode and the movable electrode. The variation in capacitance is caused by deflection of the piezoelectric piece. An oscillation loop starts from the oscillation circuit and back to the oscillation circuit via the one excitation electrode, the another excitation electrode, the movable electrode, and the fixed electrode. The piezoelectric piece, the excitation electrode, the movable electrode, and the fixed electrode constitute combinations of a first combination and a second combination. The first combination constitutes a first sensor unit by disposing a first piezoelectric piece on a first crystal plane of the crystalline body. The second combination constitutes a second sensor unit by disposing a second piezoelectric piece on a second crystal plane. The second crystal plane does not opposite to the first crystal plane of the crystalline body. A relative position of the second crystal plane with respect to the first crystal plane is obtained.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view schematically illustrating a first embodiment to which an external force detection sensor according to this disclosure is applied as an acceleration detection sensor;

FIG. 2 is a plan view schematically illustrating the acceleration detection sensor;

FIG. 3 is a side view schematically illustrating the acceleration detection sensor;

FIG. 4 is a perspective view illustrating a crystalline body of a quartz crystal;

FIG. 5 is a vertical cross-sectional side view illustrating a main portion of the acceleration detection sensor;

FIG. 6A is a plan view illustrating a crystal resonator of the acceleration detection sensor;

FIG. 6B is a bottom view illustrating the crystal resonator of the acceleration detection sensor;

FIG. 7 is a plan view illustrating the acceleration detection sensor;

FIG. 8 is a block diagram illustrating a circuit configuration of an acceleration detection apparatus;

FIG. 9 is a circuit diagram illustrating an equivalent circuit of the acceleration detection apparatus;

FIG. 10 is a graph illustrating a relationship between acceleration obtained with the acceleration detection apparatus and frequency difference;

FIG. 11 is a schematic perspective view illustrating another example of the acceleration detection sensor;

FIG. 12 is a vertical cross-sectional side view illustrating another example of the acceleration detection sensor;

FIG. 13 is a side view illustrating a method for evaluating a posture of the acceleration detection sensor;

FIG. 14 is a side view illustrating the method for evaluating the posture of the acceleration detection sensor;

FIG. 15 is a side view illustrating the method for evaluating the posture of the acceleration detection sensor;

FIG. 16 is a graph illustrating a characteristic of the acceleration detection sensor;

FIG. 17 is a graph illustrating a characteristic of the acceleration detection sensor;

FIG. 18 is a side view illustrating a method for evaluating a posture of the acceleration detection sensor;

FIG. 19 is a side view illustrating the method for evaluating the posture of the acceleration detection sensor;

FIG. 20 is a graph illustrating a characteristic of the acceleration detection sensor;

FIG. 21 is a graph illustrating a characteristic of the acceleration detection sensor;

FIG. 22 is a side view illustrating a tool used for evaluating a posture of the acceleration detection sensor;

FIG. 23 is a graph illustrating a characteristic of the acceleration detection sensor; and

FIG. 24 is a graph illustrating a characteristic of the acceleration detection sensor.

### DETAILED DESCRIPTION

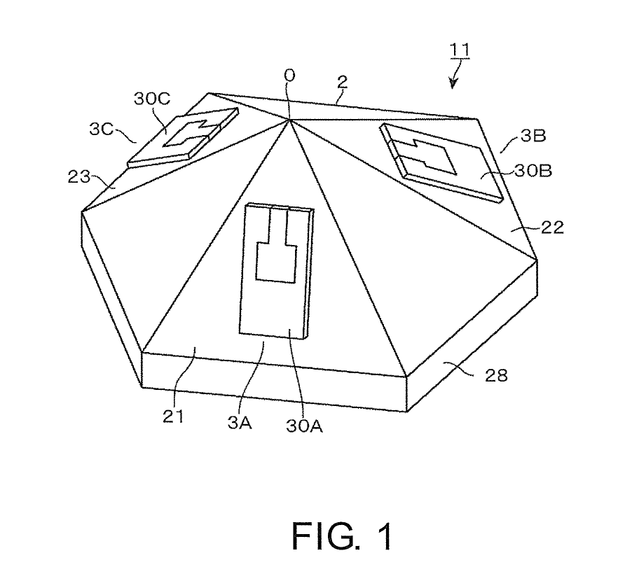

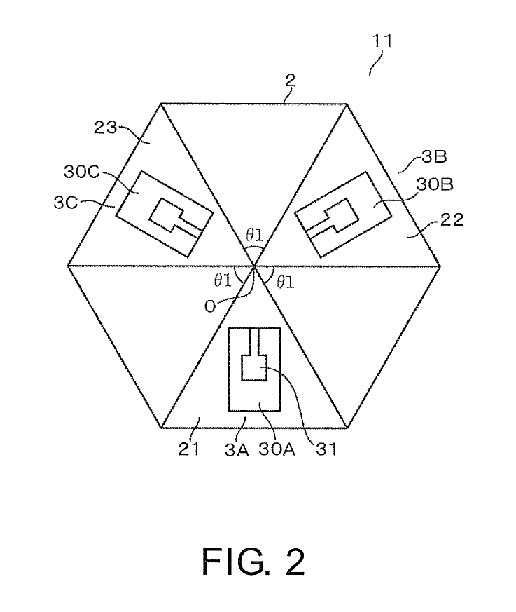

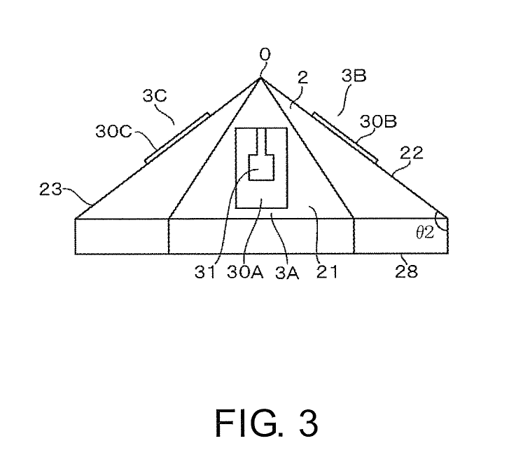

An embodiment where external force detection equipment according to this disclosure is applied to an acceleration detection apparatus will be described by referring to the drawings. FIG. 1 is a schematic perspective view of an acceleration detection sensor of the acceleration detection apparatus. FIG. 2 and FIG. 3 are respectively a schematic plan view and a schematic side view of the acceleration detection sensor. This acceleration detection sensor 11 is, as illustrated in FIG. 1 to FIG. 3, constituted by mounting crystal resonators 3A to 3C on a crystalline body 2. This acceleration detection sensor 11 corresponds to an external force detection sensor that is a sensor portion of the acceleration detection apparatus.

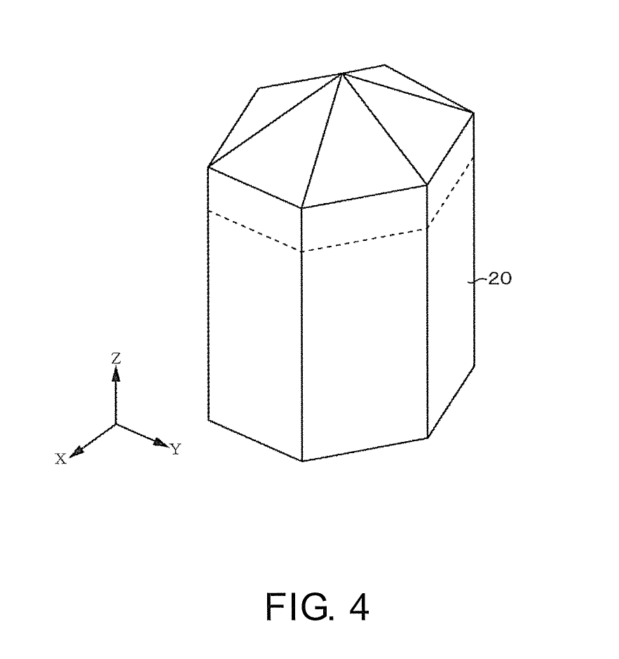

The crystalline body 2 employs, for example, a natural quartz crystal 20. This natural quartz crystal 20 has, as illustrated in a figure of FIG. 4, a regular hexagonal prism shape extending in the Z-axis direction. This natural quartz crystal 20 has both end portions in the longitudinal direction that are each constituted in a regular hexagonal pyramid shape (as illustrated in FIG. 4 where only one side is illustrated). The crystalline body 2 is constituted, as a portion to be cut is illustrated by a dotted line in FIG. 4, by cutting the natural quartz crystal 20 along the X-Y plane perpendicular to the Z-axis. Accordingly, the crystalline body 2 is constituted, as illustrated in FIG. 2, in a regular hexagonal shape in plan view.

Thus, the crystalline body 2 has a regular hexagonal pyramid-shaped portion with six inclined surfaces. These inclined surfaces alternately include R-surfaces 21 to 23. That is, the crystalline body 2 has three R-surfaces of a first R-surface 21, a second R-surface 22, and a third R-surface 23. The first R-surface 21 corresponds to a first crystal plane, the second R-surface 22 corresponds to a second crystal plane, and the third R-surface 23 corresponds to a third crystal plane. These first to third R-surfaces 21 to 23 have, as illustrated in FIG. 2, respective angles θ1 of 60 degrees with respect to one another, and have, as illustrated in FIG. 3 in side view, respective inclination angles θ2 of 120 degrees with respect to a bottom surface (a cut plane) 28. Accordingly, the first to the third R-surface 21 to 23 have the obtained relative angles with respect to one another.

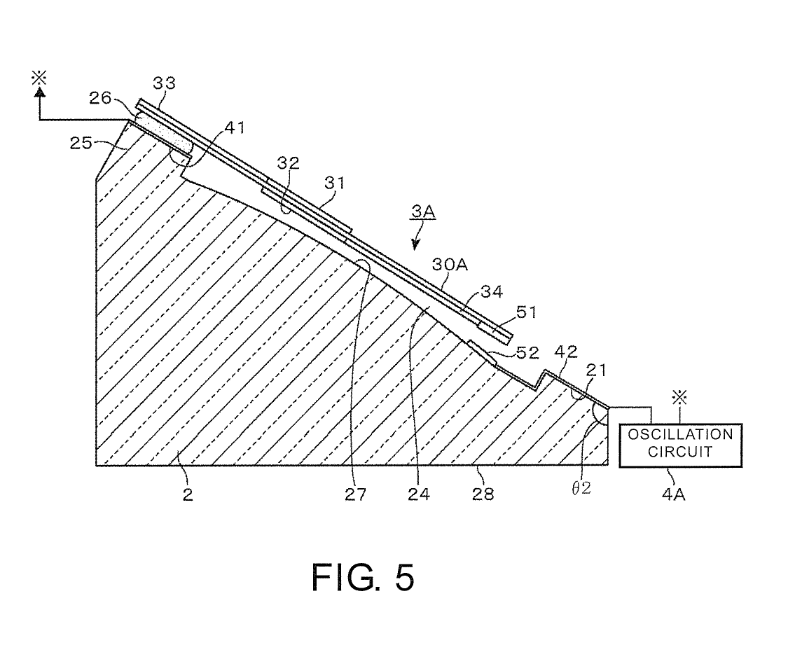

Additionally, the first R-surface 21, the second R-surface 22, and the third R-surface 23 include, as schematically illustrated in FIG. 1 to FIG. 3, piezoelectric pieces of a first crystal blank 30A, a second crystal blank 30B, and a third crystal blank 30C, respectively. These first to the third crystal blanks 30A to 30C are constituted similarly to one another, and the crystal planes 21 to 23 where the respective crystal blanks 30A to 30C are mounted are also constituted similarly to one another. Thus, the first crystal blank 30A as an example will be described by referring to FIG. 5. FIG. 5 is a vertical cross-sectional side view near the crystal plane 21 of the crystalline body 2.

The crystalline body 2 has a mounting area for the crystal blank 30A where a depressed portion 24 for ensuring a vibration space for the crystal blank 30A is formed. The depressed portion 24 has one end side formed as a pedestal 25. One end side of the crystal blank 30A is fixed on a top surface of this pedestal 25 by a conductive adhesive 26. Thus, the crystal blank 30A is supported by the pedestal 25 at the one end side. The depressed portion 24 has a quadrangular shape in plan view. The crystal blank 30A is, for example, an X-cut crystal in a shape of strip of paper and has a thickness set to, for example, the order of several tens of μm such as 0.03 mm. Therefore, applying an accelerative force in a direction intersecting with the crystal blank 30A deflects a distal end portion of the crystal blank 30A.

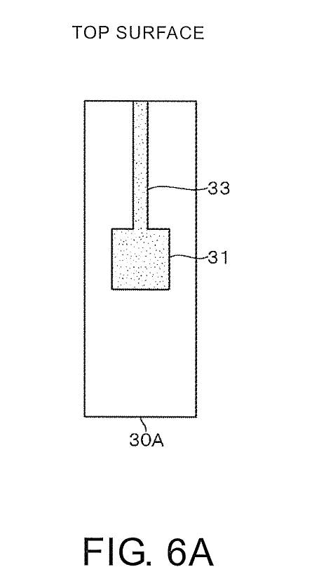

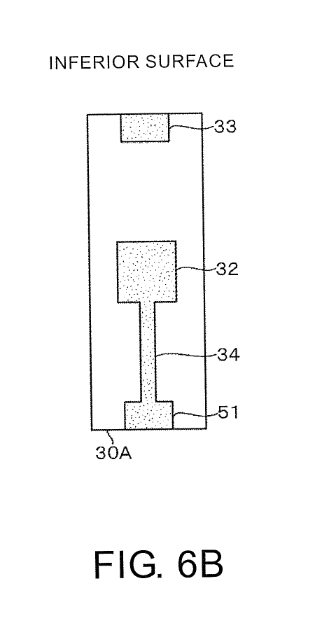

The crystal blank 30A includes, as illustrated in FIG. 6A, one excitation electrode 31 on a top surface in the center portion. The crystal blank 30A includes, as illustrated in FIG. 6B, the another excitation electrode 32 on an inferior surface in a portion opposite to the excitation electrode 31. This forms the crystal resonator 3A. The excitation electrode 31 at the top surface side connects to an extraction electrode 33 in a strip shape. As illustrated in FIG. 5, this extraction electrode 33 is folded at the one end side of the crystal blank 30A to the inferior surface, and is brought in contact with the conductive adhesive 26. The pedestal 25 has a top surface where a conductive path 41 formed of a metal layer is disposed. This conductive path 41 connects to one end of a first oscillation circuit 4A via the crystalline body 2.

The excitation electrode 32 at the inferior surface side connects to an extraction electrode 34 in a strip shape. This extraction electrode 34 is extracted to the other end side (the distal end side) of the crystal blank 30A, and connects to a movable electrode 51 for forming variable capacitance. On the other hand, at the crystalline body 2 side, a fixed electrode 52 for forming variable capacitance is disposed. The depressed portion 24 has a protruding portion 27 in a convex shape. This protruding portion 27 has a quadrangular shape in plan view. This disclosure detects an external force through capacitance change between the movable electrode 51 and the fixed electrode 52 generated based on deformation of the crystal blank 30A. Therefore, the movable electrode 51 is also referred to as a detection electrode.

The fixed electrode 52 in this protruding portion 27 substantially faces the movable electrode 51. The crystal blank 30A has a nature that when the crystal blank 30A vibrates excessively and its distal end collides with the depressed portion 24, a crystal mass of the crystal blank 30A is easily chipped due to a phenomenon called “cleavage”. Accordingly, a shape of the protruding portion 27 is determined such that when the crystal blank 30A vibrates excessively, a portion at a base end side (the one end side) of the crystal blank 30A rather than the movable electrode 51 collides with the protruding portion 27. In FIG. 5 and a similar drawing, an aspect slightly different from the actual device is illustrated. Actually, the crystal blank 30A has a configuration where a portion near the center rather than the distal end collides with the protruding portion 27.

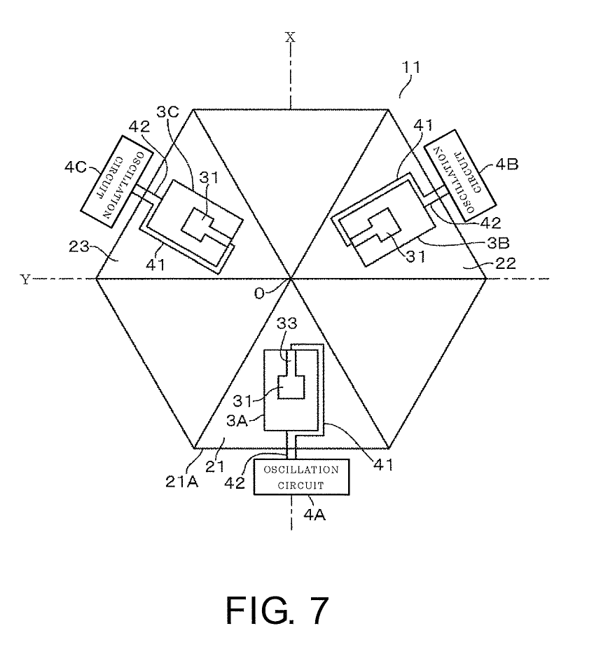

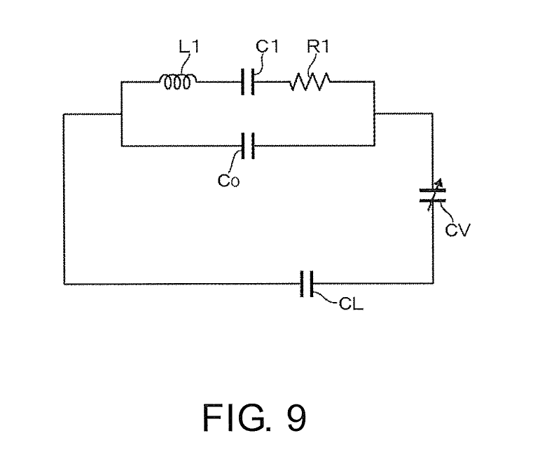

The fixed electrode 52 connects to the other end of the first oscillation circuit 4A via a conductive path 42. The conductive path 42 is wired via a surface of the protruding portion 27 and a surface of the crystalline body 2. FIG. 7 schematically illustrates a connected state of wiring of the acceleration detection sensor 11, and FIG. 9 illustrates an equivalent circuit. L1 denotes series inductance corresponding to the mass of the crystal resonator, C1 denotes series capacitance, R1 denotes a series resistance, CO denotes effective shunt capacitance including interelectrode capacitance. While the excitation electrode 31 at the top surface side and the excitation electrode 32 at the inferior surface side each connect to the first oscillation circuit 4A, a variable capacitance Cv is interposed between the excitation electrode 32 at the inferior surface side and the oscillation circuit 4A. The variable capacitance Cv is formed between the movable electrode 51 and the fixed electrode 52.

A weight may be disposed on the distal end portion of the crystal blank 30A so as to increase a deflection amount when acceleration is applied. In this case, the thickness of the movable electrode 51 may be increased to double as the weight, the weight may be disposed separately from the movable electrode 51 at the inferior surface side of the crystal blank 30A, or the weight may be disposed at the top surface side of the crystal blank 30A.

Here, according to the international standard IEC 60122-1, a general equation of the crystal oscillation circuit is represented as following equation (1).

FL=Fr×(1+x)

x=(C1/2)×1/(C0+CL) (1)

FL is an oscillation frequency when a load is applied to the crystal resonator, and Fr is a resonance frequency of the crystal resonator itself.

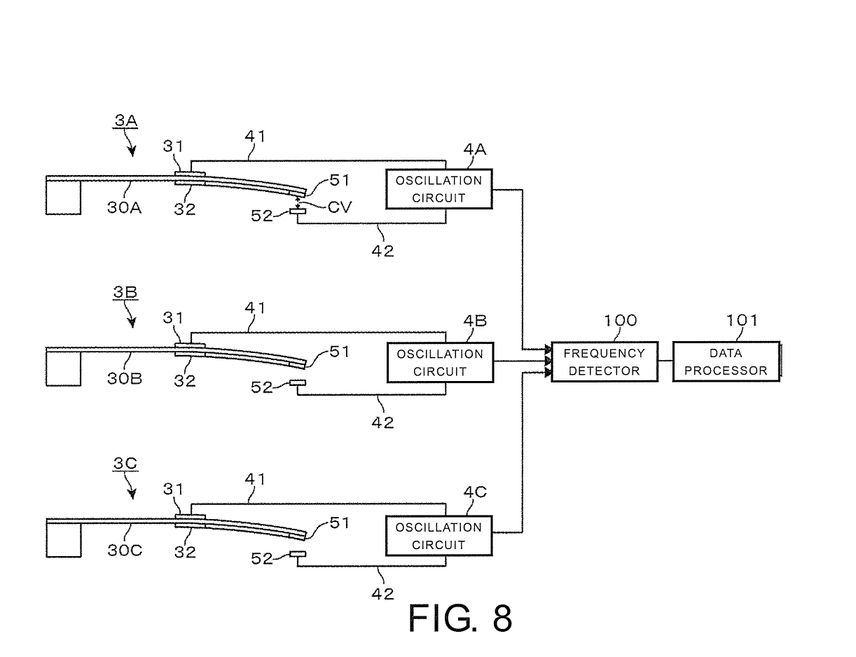

In this embodiment, as illustrated in FIG. 8 and FIG. 9, load capacitance of the crystal blank 30A is the sum of CL and Cv. Therefore, y represented by equation (2) is substituted instead of CL in equation (1).

y=1/(1/Cv+1/CL) (2)

Therefore, if a deflection amount of the crystal blank 30 changes from state 1 to state 2 and this changes the variable capacitance Cv from Cv1 to Cv2, a frequency change dFL is represented by equation (3).

dFL=FL1−FL2=A×CL²×(Cv2−Cv1)/(B×C) (3)

Here,

A=C1×Fr/2

B=C0×CL+(C0+CL)×Cv1

C=C0×CL+(C0+CL)×Cv2

Additionally, in a state where no acceleration is applied to the crystal blank 30A, so to speak, a reference state, a separation distance between the movable electrode 51 and the fixed electrode 52 is assumed to be d1. In a state where acceleration is applied to the crystal blank 30, the separation distance is assumed to be d2. In this case, the following equation (4) holds true.

Cv1=S×ε/d1

Cv2=S×ε/d2 (4)

Here, S is an area of a facing area of the movable electrode 51 and the fixed electrode 52, and ε is a relative permittivity. Since d1 is already known, it can be seen that dFL and d2 have a correspondence relationship.

As a sensor portion of this embodiment, the acceleration detection sensor may have the slightly deflected crystal blank 30A even in a state where no external force corresponding to acceleration is applied. A thickness of the crystal blank 30A or similar parameter determines whether the crystal blank 30A is in a deflected state or the crystal blank 30A is retained in a horizontal state.

When vibration is applied, the crystal blank 30A is deflected as illustrated in FIG. 8. As described above, in the reference state where no external force is applied to the crystal blank 30A, a capacitance between the movable electrode 51 and the fixed electrode 52 is assumed to be Cv1. In this case, deflecting the crystal blank 30A by an external force applied to the crystal blank 30A changes the distance between both electrodes 51 and 52, thus changing the capacitance from Cv1. This changes the oscillation frequency output from the first oscillation circuit 4A.

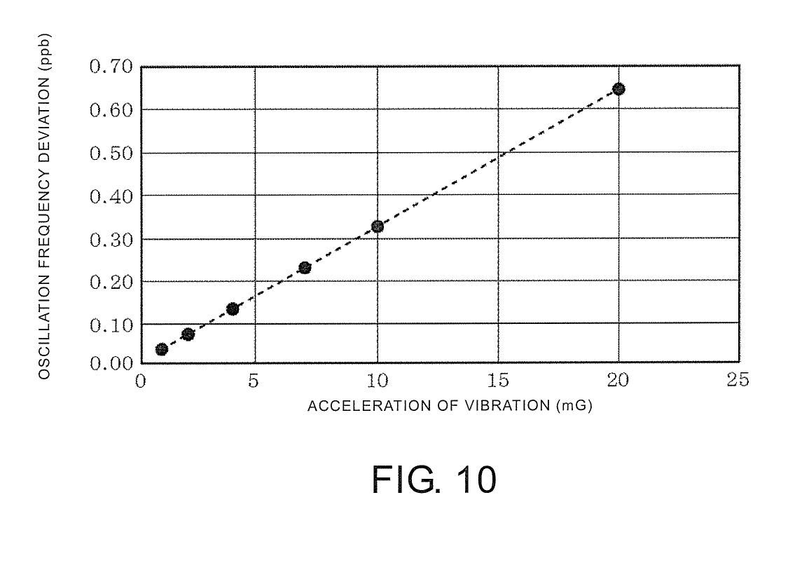

A frequency detected by a frequency detector 100 as a frequency information detector in a state where no vibration is applied is assumed to be FL1, and a frequency when vibration (acceleration) is applied is assumed to be FL2. At this time, a frequency difference FL1−FL2 is represented by equation (3). The inventors calculated a change rate of the frequency when the state changes from state 1 to state 2 from the frequency difference FL1−FL2, and investigated a relationship between a frequency change rate {(FL1−FL2)/FL1} and acceleration so as to obtain a relationship as illustrated in FIG. 10. Therefore, this proves that acceleration is obtained by measuring the frequency difference. Here, a value of FL1 is set to a value of FL1 at a reference temperature, for example, 25° C. in the case where the reference temperature is set to a certain temperature.

The second crystal blank 30B and the third crystal blank 30C are constituted similarly to the first crystal blank 30A, and are respectively mounted on a second R-surface 22 and a third R-surface 23 of the crystalline body 2. Accordingly, the first to third crystal resonators 3A to 3C are mounted on the crystalline body 2. The first to third oscillation circuits 4A to 4C are provided corresponding to the respective first to third crystal resonators 3A to 3C. Thus, a first combination of the first crystal blank 30A, the excitation electrodes 31 and 32, the movable electrode 51, and the fixed electrode 52 constitutes a first sensor unit. A second combination of the second crystal blank 30B, the excitation electrodes 31 and 32, the movable electrode 51, and the fixed electrode 52 constitutes a second sensor unit. A third combination of the third crystal blank 30C, the excitation electrodes 31 and 32, the movable electrode 51, and the fixed electrode 52 constitutes a third sensor unit.

The first to third oscillation circuits 4A to 4C connect to the frequency detector 100. This frequency detector 100 acquires frequency information of the first to third crystal resonators 3A to 3C. A data processor 101 constituted of, for example, a personal computer includes an operator and a display unit. The operator operates a direction and an acceleration of the vibration, for example, using a determinant based on the frequency information such as a frequency. The display unit displays a result of the operation. The frequency information is not limited to change in frequency difference, and may be a frequency difference itself.

The acceleration detection sensor 11 thus configured is mounted on a measurement target, for example, as illustrated in FIG. 7, such that the bottom surface (the cut plane) 28 of the crystalline body 2 becomes horizontal, and positions (coordinates) of the crystal planes (the R-surfaces) 21 to 22, where the crystal blanks 30A to 30C of the crystalline body 2 are mounted, are specified. For example, to describe by the orthogonal axial system, the crystalline body 2 is mounted on the measurement target as follows. The crystalline body 2 has an apex O positioned at an intersection point of the X-axis and the Y-axis. In plan view, one side of an outline of the crystalline body 2, for example, a base 21A of the R-surface 21, where the first crystal blank 30A is disposed, is parallel to the Y-axis. This mounting uses, for example, a screw while providing a slight angular variation with a secured state of the screw at this time. In the case where an earthquake occurs or a simulated vibration is applied to the acceleration detection sensor 11, measurement of the vibration with high accuracy needs measurement of amplitudes in the X-axis direction, the Y-axis direction, and the Z-axis direction since the vibration is a combination of amplitudes in three directions, which are the amplitude in the X-axis direction, the amplitude in the Y-axis direction, and the amplitude in the Z-axis direction.

This acceleration detection sensor 11 includes the crystalline body 2 with the three R-surfaces 21 to 23 where the respective crystal resonators 3A to 3C are disposed. These three crystal resonators 3A to 3C allow measurement of amplitudes (vibration sizes) in three directions. For example, in the case of a vibration in the Z-axis direction (in the vertical direction), the first to third crystal resonators 3A to 3C are all deflected in the same way so as to provide the same amount of variation for respective oscillation frequencies. In the case of a rotation vibration around the X-axis, the first crystal resonator 3A is not deflected but the second crystal resonator 3B and the third crystal resonator 3C are deflected. Accordingly, only the oscillation frequencies of the second crystal resonator 3B and the third crystal resonator 3C change. Additionally, in the case of a rotation vibration around the Y-axis, the first to third crystal resonators 3A to 3C are each deflected. However, only the first crystal resonator 3A is deflected in a way different from those of the other resonators, and the second crystal resonator 3B and the third crystal resonator 3C are deflected in the same way. Accordingly, the second crystal resonator 3B and the third crystal resonator 3C have the same variation amount of the oscillation frequencies while only the first crystal resonator 3A have a different variation amount of the oscillation frequency.

At this time, the R-surfaces 21 to 23 have determined relative angles so as to obtain the positions (the coordinates) with respect to the X-axis, the Y-axis, and the Z-axis. Accordingly, measuring the variation amounts of the oscillation frequencies of the first to third crystal resonators 3A to 3C allows operating to obtain the amplitudes in the X-axis direction, the Y-axis direction, and the Z-axis direction, for example, using a determinant.

As described above, the data processor 101 uses this determinant to obtain a difference between a frequency f0 without any acceleration and a frequency fl with acceleration in the first to third crystal resonators 3A to 3C. The data processor 101 operates the amplitudes in the X-axis direction, the Y-axis direction, and the Z-axis direction based on a frequency variation calculated from this frequency difference, and displays the result of the operation on the display unit. Accordingly, obtaining the variations of the oscillation frequencies of the first to third crystal resonators 3A to 3C allows accurately obtaining a direction of the vibration and a magnitude of the vibration (acceleration).

This embodiment bonds the first crystal blank 30A to the first crystal plane (the first R-surface 21) of the crystalline body 2, and also bonds the second crystal blank 30B to the second crystal plane (the second R-surface 22) to constitute the acceleration detection sensor 11. The first crystal plane 21 and the second crystal plane 22 do not opposite to each other, and the relative angle is preliminarily obtained. Therefore, when the acceleration detection sensor 11 is mounted on the measurement target, the relative angles of the first crystal blank 30A and the second crystal blank 30B with respect to the measurement target are automatically determined.

That is, the first crystal plane 21 has, as described above, an inclination angle of 120 degrees with respect to the bottom surface (the cut plane) 28 of the crystalline body 2. Mounting the bottom surface 28 of the crystalline body 2 on the measurement target in a horizontal position determines an inclination angle of the first crystal blank 30A with respect to the horizontal surface as 120 degrees. In this respect, the second crystal plane 22 and the third crystal plane 23 also have respective inclination angles of 120 degrees with respect to the bottom surface (the cut plane) 28 of the crystalline body 2. Accordingly, mounting the crystalline body 2 in a horizontal position also determines inclination angles of the second and third crystal blanks 30B and 30C with respect to the horizontal surface automatically. Additionally, the first to third crystal planes 21 to 23 form respective angles of 60 degrees with respect to one another. As described above, mounting the crystalline body 2 on the measurement target such that, for example, the base 21A of the first crystal plane 21 becomes parallel to the Y-axis determines the relative angles of the first to third crystal blanks 30A to 30C.

Accordingly, mounting the acceleration detection sensor 11 on the measurement target automatically determines the relative angles of the first to third crystal blanks 30A to 30C with respect to the measurement target. This eliminates the need for determining angles of the first to third crystal blanks 30A to 30C with respect to the measurement target, thus facilitating the fabrication. In this respect, mounting the crystal blanks 30A to 30C directly on the crystalline body 2 minimizes occurrence of error when mounting the crystal blanks 30A to 30C. This suppresses occurrence of an angular errors when mounting the crystal blanks 30A to 30C, and this allows performing measurement with high accuracy. Respective external forces applied to the first crystal plane 21 to the third crystal plane 23 are acquired as frequency information of the first crystal blank 30A to the third crystal blank 30C. This allows measuring an external force in three directions and consequently measures the external force with high accuracy.

At this time, in the case where the crystalline body of the quartz crystal is used as the crystalline body 2, the crystalline body of the quartz crystal has a shape of a regular hexagonal prism with an end portion in a shape of a regular hexagonal pyramid. Accordingly, a very simple method of cutting along a plane perpendicular to the longitudinal direction stably forms the crystalline body 2 in a constant form. That is, the cutting operation ensures forming of the crystalline body 2 as follows. The crystal planes (the R-surfaces) 21 to 23 where the crystal blanks 30A to 30C are always disposed to form the respective angles θ1 that are mutually the same angle of 60 degrees. Additionally, when viewed from a side view, the crystal plane (the R-surface) and the horizontal surface forms an angle (an inclination angle) θ2 of 120 degrees.

Therefore, relative positions of the crystal planes 21 to 23 are preliminarily detennined. This easily measures an external force with high accuracy by obtaining a relationship with the coordinate axes when the acceleration detection sensor 11 is mounted on the measurement target. High accuracy in the horizontal position of the bottom surface 28 of the crystalline body 2 when performing the cutting operation facilitates a calibration operation when mounting the acceleration detection sensor 11 on the measurement target. On the other hand, low accuracy in the horizontal position of the bottom surface of the crystalline body 2 requires the calibration operation. Additionally, securing the crystal blanks 30A to 30C to the R-surfaces 21 to 23 of the crystalline body 2 of the quartz crystal improves impact resistance. That is, the above-described acceleration detection sensor 11 has θ2 as the respective inclination angles of the crystal blanks 30 (30A to 30C) with respect to the horizontal surface. When an acceleration G is applied to the crystal blank 30, a gravitational acceleration Ga applied to the distal end of the crystal blank 30 is calculated by the following equation.

Ga=9.8(m/sec²)×cos θ2

Therefore, as described above, when the inclination angle is 30 degrees, Ga=0.866G is satisfied. On the other hand, when the crystal blank is disposed parallel to the horizontal surface, the formed angle θ2 becomes zero degree and the gravitational acceleration Ga satisfies Ga=1G. Thus, securing the crystal blank 30 to the crystal plane inclined to the horizontal surface provides high impact resistance so as to suppress damage and breaking of the crystal blank 30.

As described above, the above-described embodiment employs the crystalline body of the quartz crystal. Accordingly, the relative angle between the first crystal plane and the second crystal plane, the relative angle between the second crystal plane and the third crystal plane, and the relative angle between the third crystal plane and the first crystal plane are the same. However, the relative angles between the crystal planes securing these crystal blanks may have different angles from one another. Obtaining the relative angles between the crystal planes (obtaining the coordinates of the crystal planes) allows obtaining the amplitudes in the X-axis direction, the Y-axis direction, and the Z-axis direction by operation.

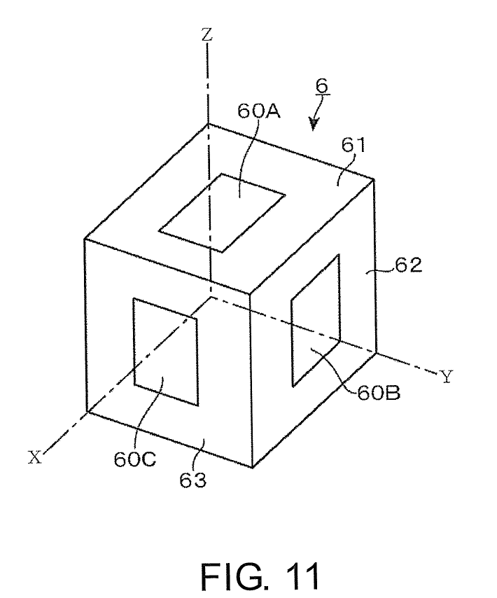

Additionally, for example, as illustrated in FIG. 11, the acceleration detection sensor may be constituted as follows. This employs a crystalline body 6 with a cubic shape or a rectangular parallelepiped shape. A first crystal blank 60A is secured to a first crystal plane 61 parallel to the horizontal surface (the X-Y plane). A second crystal blank 60B is secured to a second crystal plane 62 parallel to the X-Z plane. A third crystal blank 60C is secured to a third crystal plane 63 parallel to the Y-Z plane. The first crystal blank 60A to the third crystal blank 60C respectively constitute, similarly to the above-described embodiment, a first sensor unit to a third sensor unit as a first combination to a third combination, which each include the excitation electrode, the movable electrode, and the fixed electrode.

Additionally, the acceleration detection sensor does not necessarily include three sensor units. The acceleration detection sensor may be constituted of a first sensor unit and a second sensor unit as follows. The first sensor unit is constituted such that the first crystal blank is disposed on the first crystal plane of the crystalline body. The second sensor unit is constituted such that the second crystal blank is disposed on the second crystal plane. The second crystal plane does not opposite to the first crystal plane, and a relative position of the second crystal plane with respect to the first crystal plane is obtained. This is because obtaining vectors in two directions allows obtaining a third vector by operation. At this time, in the case where an angle formed between the two vectors becomes equal to or less than 60 degrees, an error between the value obtained by the operation and a measured value may be large. Thus, the first sensor unit and the second sensor unit are preferred to form an angle equal to or more than 60 degrees.

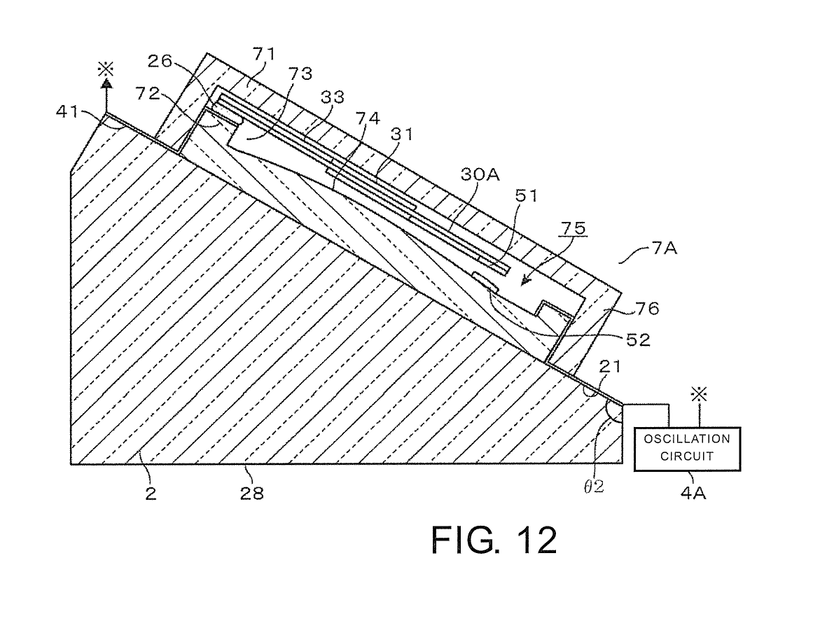

Subsequently, a description will be given of a configuration where the sensor unit 7 as a package is mounted on the crystalline body 2 by referring to FIG. 12. In this example, three R-surfaces 21 to 23 of the crystalline body 2 of the quartz crystal include respective sensor units 7 (7A to 7C: 7B and 7C are not illustrated). Using FIG. 12, a description will be given of the sensor unit 7A disposed on the R-surface 21. In FIG. 12, a container 71 is a sealed container in a rectangular parallelepiped shape where inert gas such as nitrogen gas is enclosed inside. This container 71 has one end side constituted as a pedestal 72, and includes a base body 75 and a case body 76. The base body 75 includes a depressed portion 73 continuous with the pedestal 72 and a protruding portion 74 in a convex shape. The case body 76 is disposed to surround the base body 75 from the upper side. The base body 75 and the case body 76 are formed of, for example, quartz crystal. The base body 75 and the case body 76 have bottom surfaces as horizontal surfaces. In the pedestal 72, the first crystal blank 30A is secured by a conductive adhesive 26.

The first crystal blank 30A is constituted similarly to the above-described embodiments. The first crystal blank 30A constitutes the first crystal resonator 3A, and has a distal end with the movable electrode 51. The base body 75 includes the fixed electrode 52 formed in a region facing the movable electrode 51. The first crystal blank 30A has the top surface side where the excitation electrode 31 connects to one end of the first oscillation circuit 4A via the extraction electrode 33, the conductive adhesive 26, and the conductive path 41 formed of a metal layer. Additionally, the fixed electrode 52 connects to the first oscillation circuit 4A via the conductive path 42 formed of a metal layer. In this sensor unit 7A, the base body 75 and the case body 76 have inferior surfaces that are secured to the crystal planes (the R-surfaces) 21 to 23 of the crystalline body 2, for example, by an adhesive.

The sensor unit 7B with the second crystal blank 30B and the sensor unit 7C with the third crystal blank 30C are constituted similarly to the sensor unit 7A with the first crystal blank 30A. The sensor unit 7B and the sensor unit 7C are respectively mounted on the second R-surface 22 and the third R-surface 23 in the crystalline body 2. Accordingly, the first to third crystal resonators 3A to 3C are mounted on the crystalline body 2. The first to third oscillation circuits 4A to 4C are disposed corresponding to the respective first to third crystal resonators 3A to 3C. In this example, the sensor unit 7 includes the respective crystal blanks 30 on the three crystal planes (the R-surfaces 21 to 23) of the crystalline body 2. Accordingly, this measures an external force in three directions and consequently measures the external force with high accuracy.

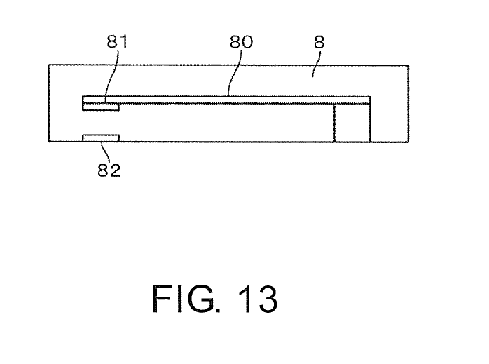

Subsequently, a method for checking whether or not the distal end of the crystal blank of the acceleration detection sensor is in a horizontal position will be described by referring to FIG. 13 to FIG. 21. This operation is performed, for example, when the crystal blank is mounted on the crystalline body 2. This example schematically illustrates an acceleration detection sensor 8 where a crystal blank 80, a movable electrode 81, and a fixed electrode 82 are illustrated.

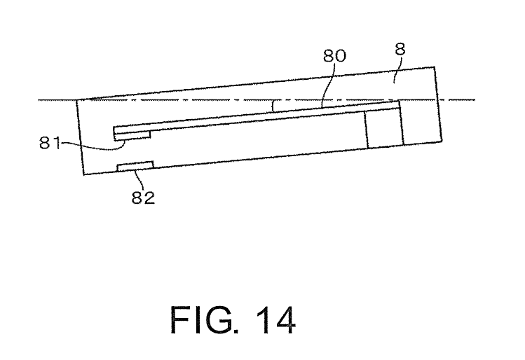

First, as illustrated in FIG. 13, the acceleration detection sensor 8 is disposed in a position A that is almost horizontal, thus acquiring a frequency f at this time (Step 1). Subsequently, as illustrated in FIG. 14, the acceleration detection sensor 8 is inclined to the left side by a predetermined angle, thus acquiring a frequency f(L) in a left inclined position B (Step 2). Subsequently, the acceleration detection sensor is returned to the original position A (the position in FIG. 13), thus acquiring a frequency at this time (Step 3).

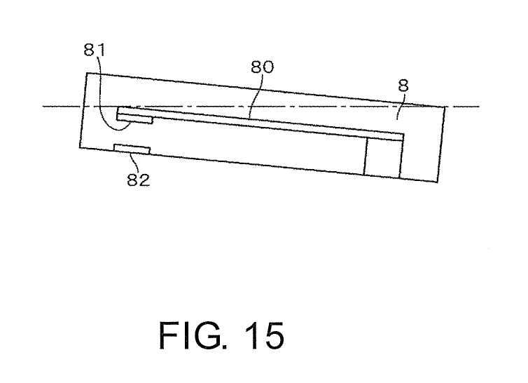

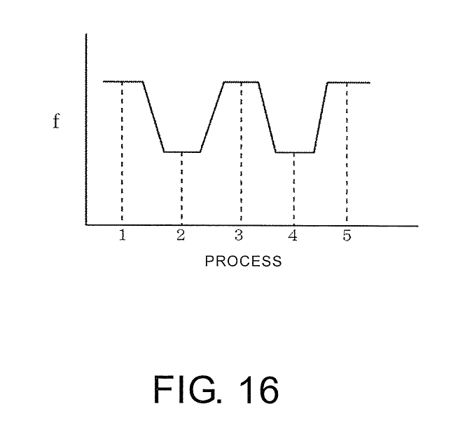

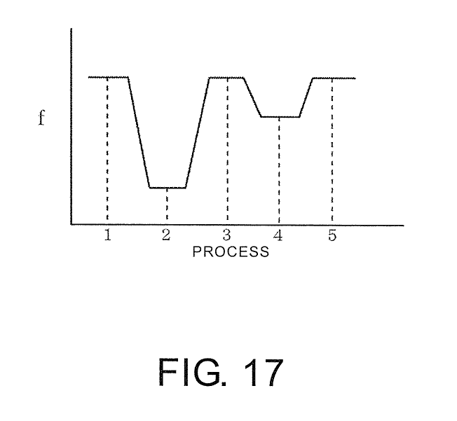

Additionally, as illustrated in FIG. 15, the acceleration detection sensor 8 is inclined to the right side by a predetermined angle, thus acquiring a frequency f(R) in a right inclined position C (Step 4). Subsequently, the acceleration detection sensor 8 is returned to the original position A, thus acquiring a frequency at this time (Step 5). Thus, a frequency variation corresponding to the positions of the acceleration detection sensor 8 is obtained as data displayed, for example, on the display unit as illustrated in FIG. 16 or FIG. 17, for example. In FIG. 16 or FIG. 17, the vertical axis denotes frequency and the horizontal axis denotes timing for frequency measurement. When the distal end of the crystal blank 80 of the acceleration detection sensor 8 is in a horizontal position, as illustrated in FIG. 16, a frequency in the left inclined position B (Step 2) and a frequency in the right inclined position C (Step 4) become the same.

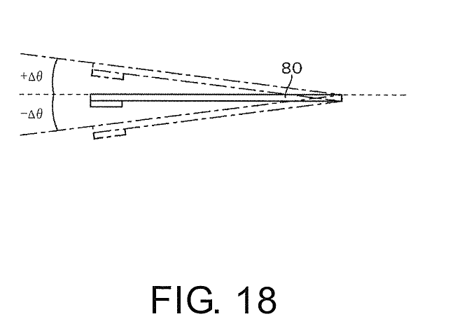

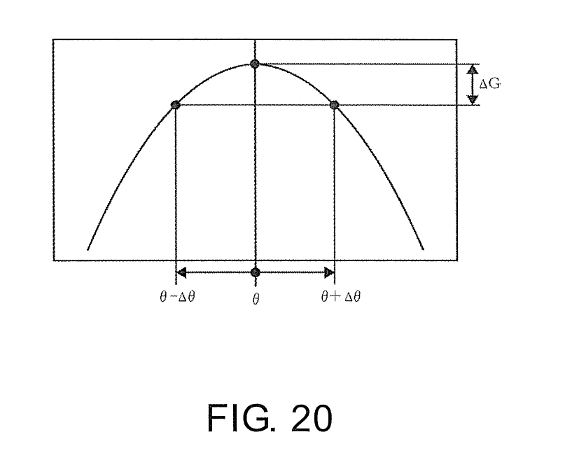

That is, as illustrated in FIG. 18, the distal end of the crystal blank 80 is in a horizontal position, the crystal blank 80 in the left inclined position is inclined by −Δθ degree with respect to the horizontal position while the crystal blank 80 in the right inclined position is inclined by +Δθ degree with respect to the horizontal position. Here, a varied acceleration ΔG when the position is inclined by ±Δθ with respect to an initial position of the crystal blank 80 is expressed by the following equation. A varied angle (Δθ) with respect to the initial position (an initial angle θ) and the varied acceleration ΔG have a relationship illustrated in FIG. 20.

ΔG=1−cos (±Δθ)

Therefore, in the case where the initial angle θ is zero deg, that is, in the case where the distal end of the crystal blank 80 is in a horizontal position, the varied accelerations ΔG when inclined by ±Δθ become the same. Here, as illustrated in FIG. 16, in the case where the frequency in the left inclined position B (Step 2) and the frequency in the right inclined position C (Step 4) are the same, the distal end of the crystal blank 80 is determined to be in a horizontal position.

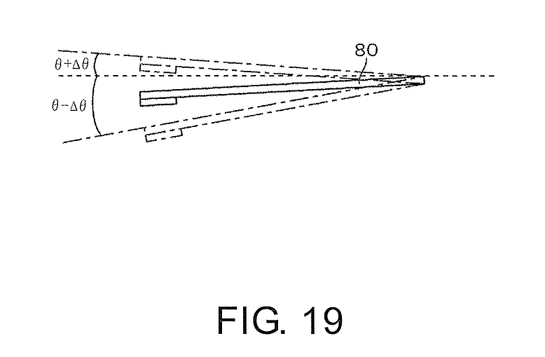

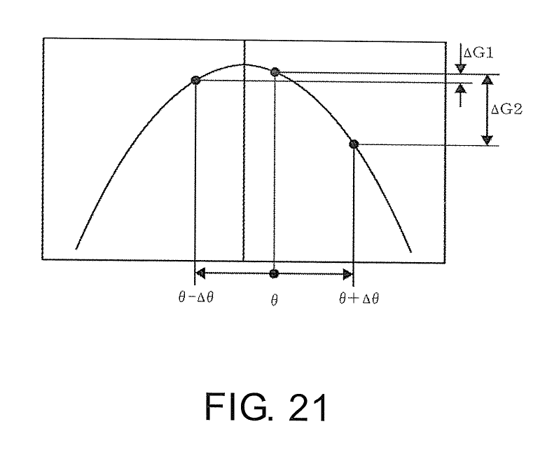

On the other hand, when the distal end of the crystal blank 80 of the acceleration detection sensor is not in a horizontal position, as illustrated in FIG. 17, the frequencies in the left inclined position B (Step 2) and the right inclined position C (Step 4) are different from each other. That is, as illustrated in FIG. 19, if the distal end of the crystal blank 80 is not in a horizontal position, the initial angle θ is not zero deg. Thus, the crystal resonator is inclined by θ−Δθ in the left inclined position while the crystal resonator is inclined by θ+Δθ in the right inclined position. Accordingly, the varied acceleration ΔG1 in the left inclined position and the varied acceleration ΔG2 in the right inclined position are expressed by the respective following equations, and have values different from each other. The varied angle (Δθ) with respect to the initial position (the initial angle θ) and the varied accelerations ΔG1 and ΔG2 have a relationship illustrated in FIG. 21.

ΔG1=cos θ−cos (θ−Δθ)

ΔG2=cos θ−cos (θ+Δθ)

Accordingly, performing operations of above-described Step 1 to Step 5 allows evaluating whether or not the distal end of the crystal blank 80 is in a horizontal position.

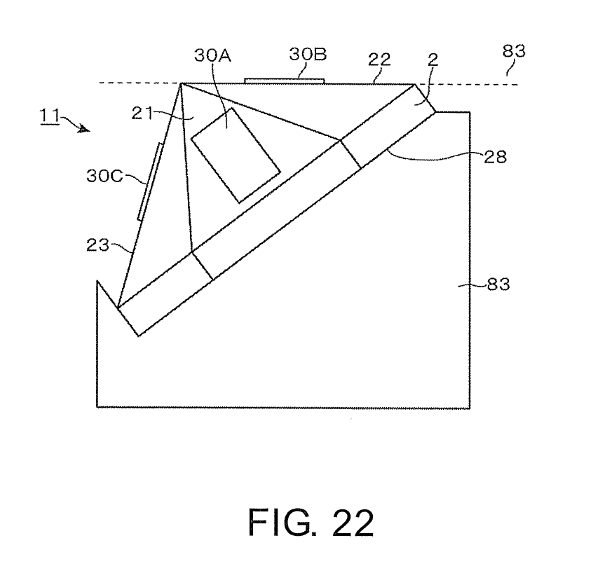

Here, for example, when the acceleration detection sensor 11 as illustrated in FIG. 1 evaluates whether or not the distal ends of the crystal blanks 30A to 30C are in horizontal positions, the above-described evaluation processes are performed. As illustrated in FIG. 22, a tool 83 for holding the crystalline body 2 is prepared such that the crystal planes (the R-surfaces) 21 to 23 become in a horizontal position, and the crystalline body 2 is placed such that the crystal blank as an evaluation target becomes in a horizontal position. FIG. 22 illustrates a dotted line that indicates a horizontal line. When performing Step 2 and Step 4, the tool is inclined to respective positions on the left and right.

Subsequently, a method for correcting the initial angle will be described. First, in a state where the initial angle θ is unknown, the acceleration detection sensor is, as described above, positioned in the left inclined position (θ−Δθ) and the right inclined position (θ+Δθ) to measure sensor outputs. The initial inclination angle θ is calculated from data at this time. These sensor outputs employ physical amounts such as capacitance, and are values based on the oscillation frequencies.

Specifically, using the above-described equation for obtaining ΔG1 and ΔG2, equation (11), and equation (12), the initial inclination angle θ is expressed by equation (13). Here, ΔG1 and ΔG2 are assumed to be accelerations, which are normalized from the sensor outputs, when about 1G is applied to the sensor. Here, the sensor output has a value corresponding to the frequency information such as the oscillation frequency.

cos (θ−Δθ)=cos θ·cos Δθ−sin θ·sin Δθ (11)

cos (θ+Δθ)=cos θ·cos Δθ+sin θ·sin Δθ (12)

θ=sin⁻¹ {(ΔG1−ΔG2)/(2·sin Δθ)} (13)

Thus, the initial inclination angle is operated. This operation means that the crystal blank 80 is in a horizontal position when the initial inclination angle is zero deg. In the case where the initial inclination angle is not zero deg, the initial position is conected such that the initial inclination angle becomes zero deg based on the operated initial inclination angle. This allows correcting the distal end of the crystal blank 80 of the acceleration detection sensor to be in a horizontal position.

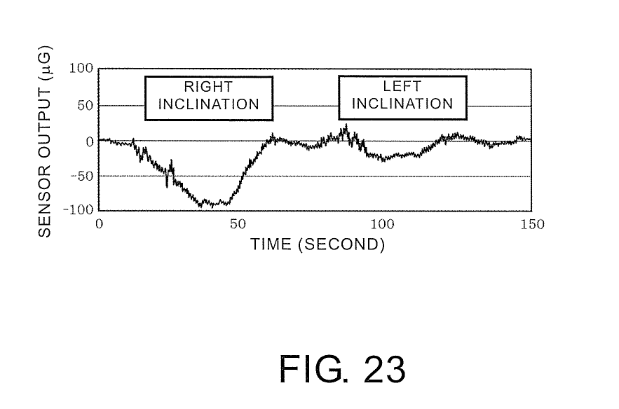

FIG. 23 illustrates an actual sensor output in the following case. First, the varied acceleration of 50 μG is actually applied to the acceleration detection sensor. Subsequently, in a state where the initial inclination angle is unknown, the acceleration detection sensor is inclined to right by 0.573 deg. Subsequently, the acceleration detection sensor is inclined to left by 0.573 deg. In the drawing, the vertical axis denotes sensor output and the horizontal axis denotes time. In this state, the distal end of the crystal blank is determined to be not in a horizontal position but inclined to the right.

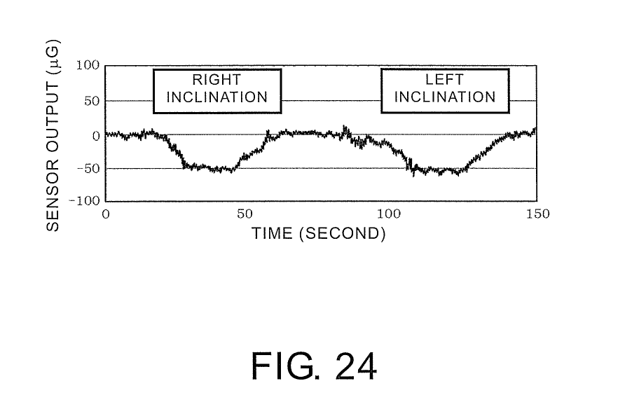

Subsequently, when the initial inclination angle is calculated with the above-described method, 0.56 deg was obtained. Accordingly, the initial position of the crystal blank was inclined to left by 0.56 deg, and the sensor output was similarly obtained. FIG. 24 illustrates this result, and this provides approximately the same sensor output in the right inclined position and the left inclined position. Accordingly, it is understood that the crystal blank in the initial position is corrected to be in a horizontal position.

This disclosure is not limited to the measurement for the acceleration. This disclosure is applicable to measurement for a magnetic force, measurement for a degree of inclination of a measured object, measurement for a flow speed of fluid, measurement for a wind velocity, and similar measurement. For example, in the case where the magnetic force is measured, the following configuration is employed. A film of magnetic material is formed in a portion between the movable electrode and the excitation electrode in the crystal blank such that the crystal blank is deflected when the magnetic material lies in a magnetic field. Additionally, in the measurement for the degree of inclination of the object to be measured, the pedestal holding the crystal blank is preliminarily inclined by various angles to obtain frequency information for each of the inclination angles. This allows detecting an inclination angle from the frequency information when the pedestal is installed on a surface to be measured. Additionally, the crystal blank is exposed in fluid such as gas or liquid to detect a flow speed through frequency information corresponding to a deflection amount of the crystal blank. In this case, a thickness of the crystal blank is determined depending on a measurement range of the flow speed and similar parameter. Additionally, this disclosure is also applicable to measurement for a gravity force.

In the above description, the crystal blank may be mounted on the crystalline body, as described above, by the adhesive such as low-melting-point glass. In the case where the crystalline body formed of quartz crystal and the crystal blank each have a smoothly formed surface to be in contact with each other, the crystal blank may be brought into contact with the crystalline body and pressed to secure each other. Additionally, eutectic bonding may be used to crystallographically bond the crystalline body and the crystal blank. Additionally, the crystalline body of this disclosure is not limited to quartz crystal, and may employ zircon, ceramic, silicon, and similar material. The piezoelectric piece may employ LiTaO₃, LiNbO₃, LiNbO₂, and similar material.

External force detection equipment according to this disclosure is for detecting an external force that acts on a piezoelectric piece. The external force detection equipment includes any of the above-described external force detection sensors and a frequency information detector configured to detect frequency information of respective signals corresponding to oscillation frequencies of the first oscillation circuit and the second oscillation circuit. The frequency information detected by the frequency information detector is used for evaluating a force acting on the piezoelectric piece.

In this disclosure, when an external force applied to the piezoelectric piece deflects the piezoelectric piece or makes a degree of deflection of the piezoelectric piece vary, capacitance between the movable electrode at the piezoelectric piece side and the fixed electrode facing the movable electrode is varied. This disclosure captures this variation in capacitance as a variation in oscillation frequency of the piezoelectric piece. Since a slight deformation of the piezoelectric piece can be detected as the variation in oscillation frequency, this allows measurement for the external force applied to the piezoelectric piece with high accuracy. At this time, a first piezoelectric piece is disposed on a first crystal plane of the crystalline body and a second piezoelectric piece is disposed on a second crystal plane to constitute the external force detection sensor. The second crystal plane does not opposite to the first crystal plane of the crystalline body, and a relative angle of the second crystal plane with respect to the first crystal plane is obtained. Thus, mounting the external force detection sensor on the measurement target automatically determines relative angles of the first piezoelectric piece and the second piezoelectric piece with respect to the measurement target. This eliminates the need for setting angles of the first and second piezoelectric pieces with respect to the measurement target, thus facilitating fabrication. Additionally, directly mounting the first and second piezoelectric pieces on the respective first and second crystal planes suppresses occurrence of an angular error when mounting and ensures measurement with high accuracy. This allows obtaining the external force applied to the first crystal plane and the external force applied to the second crystal plane as respective pieces of frequency information of the first piezoelectric piece and the second piezoelectric piece, thus ensuring measurement of the external forces with high accuracy.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An external force detection sensor, detecting an external force that acts on a piezoelectric piece, the external force detection sensor comprising:
a piezoelectric piece that has one end side supported by a pedestal being formed in a crystal plane;
one excitation electrode and another excitation electrode, the one excitation electrode being disposed at one surface side of the piezoelectric piece, the another excitation electrode being disposed at another surface side of the piezoelectric piece;
an oscillation circuit electrically connected to the one excitation electrode;
a movable electrode for forming variable capacitance disposed in a portion distant from the one end side of the piezoelectric piece, the movable electrode electrically connecting to the another excitation electrode; and
a fixed electrode separated from the piezoelectric piece, the fixed electrode facing the movable electrode, the fixed electrode connecting to the oscillation circuit, the fixed electrode forming variable capacitance with variation in capacitance between the fixed electrode and the movable electrode, the variation in capacitance being caused by deflection of the piezoelectric piece, wherein
an oscillation loop formed starting from the oscillation circuit and back to the oscillation circuit via the one excitation electrode, the another excitation electrode, the movable electrode, and the fixed electrode,
the piezoelectric piece, the excitation electrode, the movable electrode, and the fixed electrode constitute combinations of a first combination and a second combination,
the first combination constitutes a first sensor unit by disposing a first piezoelectric piece on a first crystal plane of the crystalline body, and
the second combination constitutes a second sensor unit by disposing a second piezoelectric piece on a second crystal plane, the second crystal plane not opposite to the first crystal plane of the crystalline body, a relative position of the second crystal plane with respect to the first crystal plane being obtained.

2. The external force detection sensor according to claim 1, wherein the crystalline body employs quartz crystal.

3. The external force detection sensor according to claim 1, wherein the first crystal plane and the second crystal plane are R-surfaces of quartz crystal.

4. The external force detection sensor according to claim 2, wherein the first crystal plane and the second crystal plane are R-surfaces of quartz crystal.

5. The external force detection sensor according to claim 1, wherein the piezoelectric piece employs quartz crystal.

6. The external force detection sensor according to claim 2, wherein the piezoelectric piece employs quartz crystal.

7. The external force detection sensor according to claim 3, wherein the piezoelectric piece employs quartz crystal.

8. The external force detection sensor according to claim 4, wherein the piezoelectric piece employs quartz crystal.

9. External force detection equipment, detecting an external force that acts on a piezoelectric piece, the external force detection equipment comprising:
the external force detection sensor according to claim 1; and
a frequency information detector configured to detect frequency information of respective signals corresponding to oscillation frequencies of the first oscillation circuit and the second oscillation circuit, wherein
the frequency information detected by the frequency information detector is used for evaluating a force acting on the piezoelectric piece.

10. External force detection equipment, detecting an external force that acts on a piezoelectric piece, the external force detection equipment comprising:
the external force detection sensor according to claim 2; and
a frequency information detector configured to detect frequency information of respective signals corresponding to oscillation frequencies of the first oscillation circuit and the second oscillation circuit, wherein
the frequency information detected by the frequency information detector is used for evaluating a force acting on the piezoelectric piece.

11. External force detection equipment, detecting an external force that acts on a piezoelectric piece, the external force detection equipment comprising:
the external force detection sensor according to claim 3; and
a frequency information detector configured to detect frequency information of respective signals corresponding to oscillation frequencies of the first oscillation circuit and the second oscillation circuit, wherein
the frequency information detected by the frequency information detector is used for evaluating a force acting on the piezoelectric piece.

12. External force detection equipment, detecting an external force that acts on a piezoelectric piece, the external force detection equipment comprising:
the external force detection sensor according to claim 4; and
a frequency information detector configured to detect frequency information of respective signals corresponding to oscillation frequencies of the first oscillation circuit and the second oscillation circuit, wherein
the frequency information detected by the frequency information detector is used for evaluating a force acting on the piezoelectric piece.

13. External force detection equipment, detecting an external force that acts on a piezoelectric piece, the external force detection equipment comprising:
the external force detection sensor according to claim 5; and
a frequency information detector configured to detect frequency information of respective signals corresponding to oscillation frequencies of the first oscillation circuit and the second oscillation circuit, wherein
the frequency information detected by the frequency information detector is used for evaluating a force acting on the piezoelectric piece.

14. The external force detection equipment according to claim 9, further comprising:
an operator configured to operate a direction and a magnitude of the force acting on the piezoelectric piece based on respective pieces of frequency information and a relative angle between the first crystal plane and the second crystal plane, the respective pieces of frequency information corresponding to the oscillation frequencies of the first oscillation circuit and the second oscillation circuit, the oscillation frequencies being detected by the frequency information detector.

15. The external force detection equipment according to claim 10, further comprising:
an operator configured to operate a direction and a magnitude of the force acting on the piezoelectric piece based on respective pieces of frequency information and a relative angle between the first crystal plane and the second crystal plane, the respective pieces of frequency information corresponding to the oscillation frequencies of the first oscillation circuit and the second oscillation circuit, the oscillation frequencies being detected by the frequency information detector.

16. The external force detection equipment according to claim 11, further comprising:
an operator configured to operate a direction and a magnitude of the force acting on the piezoelectric piece based on respective pieces of frequency information and a relative angle between the first crystal plane and the second crystal plane, the respective pieces of frequency information corresponding to the oscillation frequencies of the first oscillation circuit and the second oscillation circuit, the oscillation frequencies being detected by the frequency information detector.

17. The external force detection equipment according to claim 12, further comprising:
an operator configured to operate a direction and a magnitude of the force acting on the piezoelectric piece based on respective pieces of frequency information and a relative angle between the first crystal plane and the second crystal plane, the respective pieces of frequency information corresponding to the oscillation frequencies of the first oscillation circuit and the second oscillation circuit, the oscillation frequencies being detected by the frequency infoiniation detector.

18. The external force detection equipment according to claim 13, further comprising:
an operator configured to operate a direction and a magnitude of the force acting on the piezoelectric piece based on respective pieces of frequency information and a relative angle between the first crystal plane and the second crystal plane, the respective pieces of frequency information corresponding to the oscillation frequencies of the first oscillation circuit and the second oscillation circuit, the oscillation frequencies being detected by the frequency information detector.
